(19) United States
(12) Patent Application Publication
(10) Pub. No.: US 2016/0003441 A1
(43) Pub. Date: Jan. 7, 2016

(54) Ornamental Article Having Effects of Transparency or Opacity

(71) Applicant: Hua-Cheng Pan, Tainan City (TW)

(72) Inventor: Chih-Liang Wang, Tainan City (TW)

(21) Appl. No.: 14/324,057

(22) Filed: Jul. 3, 2014

(51) Int. Cl. F21V 3/04; F21V 33/00; F21V 23/00; F21V 23/04; F21S 9/02; F21S 10/04

(52) U.S. Cl. CPC F21V 3/049; F21S 9/02; F21S 10/04; F21V 23/004; F21V 23/04; F21V 33/0028; F21Y 2101/02

(57) ABSTRACT

An ornamental article with effects of transparency or opacity is provided. The ornamental article comprises a transparent ornamental main body with an accommodating space. A bottom base is combined with the ornamental main body. A switch is configured to the bottom base for selectively energizing and de-energizing said at least one light emitting device. A first metal layer and/or a second metal layer is formed on an inner surface and/or an outer surface of the ornamental main body, respectively, when the at least one light emitting device inside the ornamental main body is activated, internal image of the ornamental main body can be seen from outside of the ornamental main body.

### TECHNICAL FIELD

The present invention generally relates to an ornamental article, more particularly, to a light emitting ornamental article having effects of transparency or opacity by coating a metal film.

### BACKGROUND

Ornamental articles are typically made of metals and metal alloys. From the viewpoint of allergy prevention and weight reduction, Ti (which is a transition metal) and its alloys are employed for production of the ornamental articles.

However, ornamental articles made of metal materials are generally liable to corrode when wetted with sweat in direct contact with human skin or when exposed to salt water or rain and, therefore, have a poor corrosion resistance. Further, the ornamental articles are liable to be scratched, cracked or chipped by external shocks, as they are used in daily life.

Recently, there have been developed color ceramics such as zirconia and alumina which are superior in corrosion resistance and scratch resistance, and golden and silvery sintered alloys which are obtained by sintering a carbide or a nitride (e.g., WC, TiC, TiN) along with an alloy of iron group metals (e.g., Ni, Co).

The aforesaid color ceramics and sintered alloys exhibit their unique single colors, providing poor aesthetic effects. For improvement of the aesthetic effects, the ornamental articles are subjected to a partial coating process or to a combination process for a satin finish and a mirror finish. However, the aesthetic effects are still unsatisfactory.

As described above, the invention proposes a newly concept of transparent ornamental article different from conventional ornamental articles made of metal materials.

Accordingly, there is a possibility that the transparent ornamental article is superior to prior art's metal ornamental articles.

### SUMMARY

According to an aspect of the invention, it proposes an ornamental article with effects of transparency or opacity, comprising an ornamental main body made of a transparent material with a pattern, wherein said ornamental main body has an accommodating space. A bottom base is combined with the ornamental main body, wherein the bottom base provides a battery compartment. A circuit board is disposed (mounted) on said bottom base. At least one light emitting device is disposed on the bottom base for coupling to circuit board. A switch is configured to (disposed/mounted on) the bottom base for selectively energizing and de-energizing said at least one light emitting device. A first metal layer and/or a second metal layer is formed on an inner surface and/or an outer surface of the ornamental main body, respectively, when the at least one light emitting device inside the ornamental main body is activated, internal image of the ornamental main body can be seen from outside of the ornamental main body.

In an aspect, the ornamental article further comprises a transparent or translucent cover for partially or completely covering the at least one light emitting device. The cover has a picture formed thereon. The ornamental main body has a picture formed thereon.

In another aspect, the ornamental article further comprises an object disposed on the bottom base within the accommodating space. Material of the first metal layer or the second metal layer is selected from silver, aluminum, chromium, nickel, titanium, or the combinations thereof.

In yet another aspect, thickness of said first metal layer or said second metal layer is over 0.05 micron, for example from 0.5 micron to 3 micron.

In one aspect, pattern of said ornamental main body is lighting fixture bottle stopper, strap object, table ornament or candle.

In another aspect, the at least one light emitting device is coupled to the circuit board via a connection wire.

In yet another aspect, the ornamental article further comprises a transparent tip mounted on a top surface of the ornamental main body. One of the at least light emitting device is embedded within the transparent tip. The at least light emitting device is light emitting diode.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a perspective view of an ornamental article having effects of transparency or opacity according to the invention;

FIG. 2 illustrates a perspective view of an ornamental article having effects of transparency or opacity according to one embodiment of the invention;

FIG. 3 illustrates an expanded view of the ornamental article of the FIG. 2.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides an ornamental article having effects of transparency or opacity by coating a metal film on inner surface and/or outer surface of the ornamental article. Purpose of the invention proposes an ornamental article with light emitting function capable of showing effects of transparency and opacity. For example, housing for an ornamental article is transparent material, which may be made of various materials and hard in physical property to prevent it from breaking when subjects to impact.

The ornamental article comprises an ornamental main body, which is made of transparent material, and light emitting device configured inside of the ornamental main body. At least one metal layer can be coated on inner surface and/or outer surface of the ornamental main body. The ornamental article comprises a case in which the light emitting device is mounted for illuminating the ornamental main body. The case also defines a battery compartment configured to hold a miniature electric battery which provides the energy for illuminating the light emitting device (or lamp). A switch is mounted on the case for selectively energizing and de-energizing the light emitting device (or lamp). When the light emitting device is activated, ornamental article shows an effect of transparency. When the light emitting device is not activated, ornamental article shows an effect of opacity.

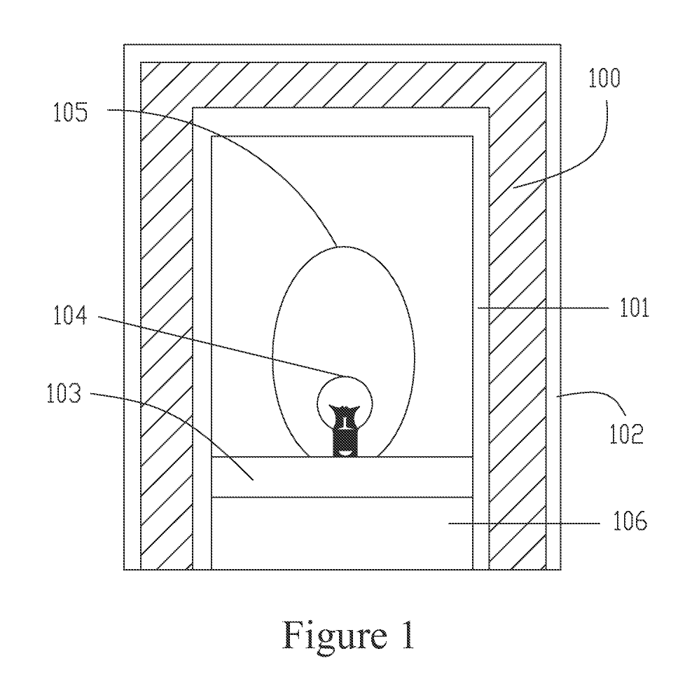

FIG. 1 shows a perspective view of a light emitting ornamental article having effects of transparency or opacity according to the invention. As shown in FIG. 1, a light emitting ornamental article includes an ornamental main body 100, which is made of transparent material, and light emitting module configured (disposed) inside of the ornamental main body 100. For example, the ornamental main body 100 is made to be a desired pattern (figure) ornamental article by an injection molding method, which has a hollow space for the light emitting module disposed therein. In one embodiment, the ornamental main body 100 has a picture formed thereon. In one embodiment, pattern (shape) of the ornamental main body 100 is lighting fixture, bottle stopper, strap object, table ornament or candle. A metal layer 101 and a metal layer 102 are coated on inner surface and outer surface of the ornamental main body 100 respectively, for example by an electroplating process. In another embodiment, only metal layer 101 or metal layer 102 is coated on inner surface or outer surface of the ornamental main body 100, respectively. The light emitting module comprises a circuit board 103 and a light emitting device 104. The ornamental main body 100 is manufactured by an integrally molding process to form a specified pattern ornamental article with an accommodating space, and its inner surface and/or outer surface electroplating a metal thin film layer.

In one embodiment, the light emitting ornamental article further includes a cover 105 and a case/bottom base 106. For example, the cover 105 has a picture formed thereon. The bottom base 106 is used for carrying the circuit board 103 and the light emitting device 104. In one embodiment, the circuit board 103 is disposed on the bottom base 106. In one embodiment, the circuit board 103 and the light emitting device 104 are mounted/disposed on the bottom base 106. In one embodiment, the cover 105 locates within the hollow space of the ornamental main body 100 and covers partially or completely light emitting device 104. Similarly, the circuit board 103 and the light emitting device 104 locate within the hollow space of the ornamental main body 100. Material of the cover 105 is transparent material or translucent material. In one embodiment, the cover 105 is disposed on the circuit board 103 or the bottom base 106. In one embodiment, the cover 105 has a specified pattern thereon. In one embodiment, an object may be disposed on the bottom base 106 within accommodating space of the ornamental main body, adjacent to the light emitting device 104.

In one embodiment, light emitting device 104 is a light emitting diode or lamp. The light emitting device 104 is activated by a control circuit. The control circuit may be configured on the circuit board 103. The circuit board 103 is for example a printed circuit board. A switch may be coupled to the circuit board 103 for switching on/off state of the light emitting device 104. The switch is configured on the bottom base 106. The circuit board 103 is electrically connected to a power source, such as battery. For example, the circuit board 103 is electrically connected to battery via a connection line (wire).

As noted above, material of the ornamental main body 100 is transparent material, such as PVC plastic material. The ornamental main body 100 may be a transparent plastic article. Material of the metal layer 101 or metal layer 102 may be selected from silver, aluminum, chromium, nickel, titanium, or the combinations thereof. The thickness of the metal layer 101 or metal layer 102 is over 0.05 micron (μm), for example from 0.5 micron to 3 micron. The transparent ornamental main body 100 is coated by metal layer with preselected thickness such that the light emitting device 104 inside the transparent ornamental main body 100 is activated, then internal image of the ornamental main body 100 can be seen from outside. When the light emitting device 104 is not activated, internal image of the ornamental main body 100 can not be seen from outside.

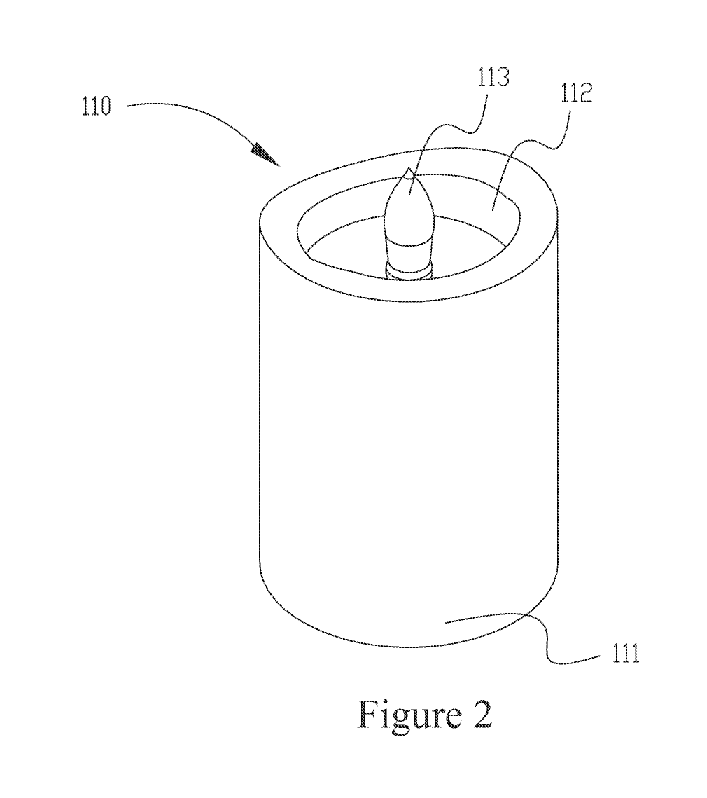

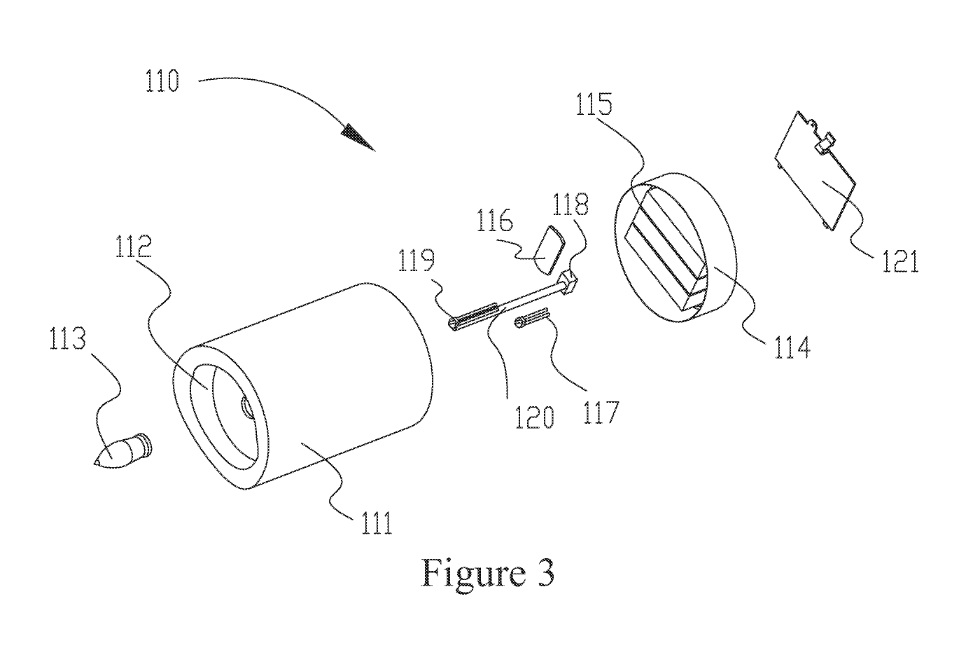

FIG. 2 and FIG. 3 show a perspective view of an ornamental article having effects of transparency or opacity according to one embodiment of the invention. As shown in FIG. 2, an ornamental article 110 has an ornamental main body 111, which is made of transparent material, and a transparent tip 113 mounted on a top surface of the ornamental main body 111 for light passing through, within a recess region 112 on top of the ornamental main body 111. For example, the ornamental main body 111 is made to be a desired pattern (figure) ornamental article by an injection molding method, which has a hollow space for the light emitting module disposed therein. An expanded view of the ornamental article is shown in the FIG. 3. A first metal layer and a second metal layer are coated on inner surface and outer surface of the ornamental main body 110 respectively, for example by an electroplating process. In another embodiment, only the first metal layer or the second metal layer is coated on inner surface or outer surface of the ornamental main body 110, respectively. The light emitting module comprises a circuit board 116 and a light emitting device 119 and 117. In one embodiment, the light emitting device 119 is embedded within internal of the transparent tip 113. The light emitting device 119 is connected (coupled) to a connection wire 120 fixed on a base 118. The light emitting device 119 is connected (coupled) to the circuit board 116 via the connection wire 120 and another connection wire (not shown). The light emitting device 117 is connected (coupled) to the circuit board 116 via a connection wire (not shown). In one embodiment, the light emitting ornamental article 110 further includes a case/bottom base 114. The bottom base 114 defines/provides a battery compartment 115 configured to hold a miniature electric battery which provides the energy for illuminating the light emitting device 117 and 119. In one embodiment, the circuit board 116, the light emitting device 117 and the base 118 are mounted on the bottom base 114. For example, the circuit board 116 and the light emitting device 117, 119 locate within the hollow space of the ornamental main body 111, or at a suitable position in the internal of the ornamental main body 111. In one embodiment, a transparent or translucent object may be disposed on the bottom base 114.

In this embodiment, the ornamental main body 111 is combined with (fixed to) the bottom base 114 to form the ornamental article 110. For example, a bottom cover 121 may be combined with or detachable from the bottom base 114.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. An ornamental article with effects of transparency or opacity, comprising:
an ornamental main body made of a transparent material with a pattern, wherein said ornamental main body has an accommodating space;
a bottom base combined with said ornamental main body;
a circuit board disposed on said bottom base;
at least one light emitting device disposed on said bottom base for coupling to said circuit board;
a switch configured to said bottom base for selectively energizing and de-energizing said at least one light emitting device;
wherein a first metal layer and/or a second metal layer is formed on an inner surface and/or an outer surface of said ornamental main body, respectively, when said at least one light emitting device inside said ornamental main body is activated, internal image of said ornamental main body can be seen from outside.

2. The ornamental article of claim 1, further comprising a transparent or translucent cover for partially or completely covering said at least one light emitting device.

3. The ornamental article of claim 2, wherein said cover has a picture formed thereon.

4. The ornamental article of claim 1, further comprising an object disposed on said bottom base within said accommodating space.

5. The ornamental article of claim 1, wherein material of said first metal layer or said second metal layer is selected from silver, aluminum, chromium, nickel, titanium, or the combinations thereof.

6. The ornamental article of claim 1, wherein thickness of said first metal layer or said second metal layer is over 0.05 micron.

7. The ornamental article of claim 1, wherein thickness of said first metal layer or said second metal layer is from 0.5 micron to 3 micron.

8. The ornamental article of claim 1, wherein said pattern of said ornamental main body is lighting fixture.

9. The ornamental article of claim 1, wherein said pattern of said ornamental main body is bottle stopper.

10. The ornamental article of claim 1, wherein said pattern of said ornamental main body is strap object.

11. The ornamental article of claim 1, wherein said pattern of said ornamental main body is table ornament.

12. The ornamental article of claim 1, wherein said pattern of said ornamental main body is candle.

13. The ornamental article of claim 1, wherein said at least one light emitting device is coupled to said circuit board via a connection wire.

14. The ornamental article of claim 1, further comprising a transparent tip mounted on a top surface of said ornamental main body.

15. The ornamental article of claim 14, wherein one of said at least light emitting device is embedded within said transparent tip.

16. The ornamental article of claim 1, wherein said at least light emitting device is light emitting diode.

17. The ornamental article of claim 1, wherein said at least light emitting device is lamp.

18. The ornamental article of claim 1, wherein said ornamental main body has a picture formed thereon.

19. The ornamental article of claim 1, wherein bottom base provides a battery compartment.
